(19) United States
(12) Patent Application Publication
(10) Pub. No.: US 2014/0279007 A1
(43) Pub. Date: Sep. 18, 2014

(54) METHOD FOR PERSONALIZED CONTEXT-AWARE, AND PRIVACY PRESERVING REAL-TIME BROKERAGE FOR ADVERTISING

(71) Applicant: ROBERT BOSCH GMBH, Stuttgart (DE)

(72) Inventors: SOUNDARARAJAN SRINIVASAN, San Francisco, CA (US); Juergen Heit, Sunnyvale, CA (US); Caio Soares, Redwood City, CA (US); Jo-Anne Ting, San Francisco, CA (US)

(73) Assignee: Robert Bosch GmbH, Stuttgart (DE)

(21) Appl. No.: 13/828,817

(22) Filed: Mar. 14, 2013

(51) Int. Cl. G06Q 30/02

(52) U.S. Cl. CPC G06Q 30/0261
USPC 705/14.58

(57) ABSTRACT

A real-time and privacy-preserving method for delivering personalized information to a user within a specific geographical location is provided. The method comprises the steps of: storing information specific to a user in a database maintained by a centralized brokerage service; transmitting a user initiated request to the centralized brokerage service to provide a listing of products and services offered by retailers or third parties located in the approximate current geographical vicinity of the user; utilizing the stored information of the user to generate a personalized listing of products and services offered within the approximate current geographical vicinity of the user; and sending the generated personalized listing to the user.

### BACKGROUND OF THE INVENTION

This disclosure relates to the field of information systems and data mining, and more particularly to a method and system for enabling retailers and service providers to market and advertise products and services to potential customers that are geographically located close in proximity to one of their stores, facilities and/or points of service.

The current wide-spread adoption of network-enabled mobile electronic devices, such as smart phones and automotive navigations systems, has provided new opportunities for delivering value adding services on such devices. Currently, these new services can cater successfully to personal preferences and needs of end customers, thereby increasing accessibility even of niche markets. In this way, a great number of formerly small market segments have grown to rival mainstream commodities.

Current information systems primarily fall into one of two categories—i.e., those offering personalized offers from retailers, and those offering personalized and localized offers (using geographical location) from retailers. To develop and customize personalized preferences of users subscribed to these offer-based services, current information systems typically require that some level of the user's personal information be shared with the retailers and/or service providers. While there have been some efforts to preserve the privacy of customers (e.g., by generalizing or de-identifying the customer's shared or demographic information), many of these systems still require some amount of the customer's personal information to be provided to the retailers and services providers upon their registration to these offer-based services.

It would be desirable to have a system and method for providing customers personalized offers when they are located in the geographical vicinity of a retailer and/or service provider that is offering a product or service that matches their interests, preferences and needs, yet doing so in such a manner that the customer's personal information is not shared with retailers or compromised throughout the process. Such a system and/or method could provide a means of preserving the privacy of the customer, while still providing personalized and localized offers that are relevant to the customer's personal preferences and needs.

### SUMMARY OF THE INVENTION

The disclosed system and method utilizes technology for large-scale information systems, statistical predictive modeling, and software user interfaces and can be configured to deliver information on network-enabled mobile electronic devices.

According to one embodiment of the disclosure, a real-time and privacy-preserving method for delivering personalized information to a user within a specific geographical location is provided. The method comprises the steps of storing information specific to a user in a database maintained by a centralized brokerage service; transmitting a user initiated request to the centralized brokerage service to provide a listing of products and services offered by retailers located in the approximate current geographical vicinity of the user; utilizing the stored information of the user to generate a personalized listing of products and services offered within the approximate current geographical vicinity of the user; and sending the generated personalized listing to the user in real-time.

In accordance with another aspect of the disclosure, the real-time and privacy-preserving method for delivering personalized information to a user within a specific geographical location comprises the steps of registering offers with a centralized brokerage service, the offers being associated with various products and services offered by a plurality of retailers; comparing the registered offers with user profiles stored in a database maintained by the centralized brokerage service to identify one or more registered offers of which a user may have some personal interest in receiving from the centralized brokerage service; permitting the centralized brokerage service to access geographical location information of the user; receiving a request from the user to view registered offers of any of the plurality of retailers that are located in the approximate vicinity of the user's current geographical location; and sending to the user one or more registered offers that are being offered by a retailer in the approximate vicinity of the user's current geographical location.

According to yet another embodiment of the disclosure, the real-time and privacy-preserving method for delivering personalized information to a user within a specific geographical location comprises the steps of providing a centralized brokerage service having a database containing a listing of various products and services offered by a plurality of retailers registered with the centralized brokerage service; comparing the various products and services offered by the plurality of retailers with user profiles stored within the database, each user profile containing information representative of a registered user's personal preferences, interests and needs; receiving a request from a registered user to view a listing of products and services offered by any of the plurality of retailers that match their user profile and are located in the approximate vicinity of the user's current geographical location; determining the user's current geographical location; and sending to the user the listing of products and services offered by the plurality of retailers that match their user profile. According to this embodiment, the user's profile contains personal information of the registered user and is accessible solely by the user and when the user requests the centralized brokerage service for matching offers and the user profile is not shared with the plurality of retailers.

### BRIEF DESCRIPTION OF THE DRAWINGS

The above mentioned and other features and objects of this disclosure, and the manner of attaining them, will become more apparent and the disclosure itself will be better understood by reference to the following description of embodiments of the disclosure taken in conjunction with the accompanying drawings, wherein:

FIG. 1 is a diagram showing an exemplary architectural schematic for an information delivery system according to one embodiment of the disclosure; and

FIG. 2 is a block diagram showing sequential actions associated with an exemplary information delivery method according to one embodiment of the disclosure.

Corresponding reference characters indicate corresponding parts throughout the several views. Although the exemplification set out herein illustrates embodiments of the disclosure, in several forms, the embodiments disclosed below are not intended to be exhaustive or to be construed as limiting the scope of the disclosure to the precise forms disclosed.

### DESCRIPTION OF EXEMPLARY EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the disclosed aspects of the disclosure, as generally described herein, and illustrated in the Figures, may be arranged, substituted, combined, and designed in a wide variety of different configurations, all of which are explicitly contemplated and make part of this disclosure.

Turning now to the drawings, FIG. 1 is a diagram illustrating components of an exemplary system 100 for implementing embodiments consistent with the disclosure. By way of example, system 100 may be implemented to provide users of an offer-based system, real-time, location-based and personalized communication services, such as location-based products and services that are being offered by various retailers and service providers. As further disclosed herein, a user or customer 102 having a network-enabled mobile electronic device (e.g., a cellular telephone, a personal computer (PC), a tablet, a laptop and any telephony enabled personal digital assistant (PDAs) or the like) creates a user profile with a centralized broker service 104. The centralized broker 104, in turn, maintains a database repository 106 that includes information related to the users' profiles.

In accordance with one aspect of the disclosure, a user 102 completes a survey or questionnaire provided by the broker 104 to establish a personalized user profile that is representative of their individual preferences and/or interests in various types of products and/or service offerings. The survey or questionnaire, for instance, may ask the user 102 certain demographic questions to help identify personality characteristics of the user, as well as ask them to identify their likes and dislikes. While not being limited herein, particularly as those skilled in the relevant art will understand and appreciate that any number of questions can be asked to the user depending on the application of the inventive method and system, some of the information that can be provided by the user may include their age, gender, race, ethnicity, educational background, city of residence, disabilities, mobility, home ownership, employment status, hobbies, food preferences etc.

While it should be understood and appreciated herein that various levels of security can be established and exercised by the broker 104 when utilizing the inventive methods and systems disclosed herein, to maintain the privacy of the user 102 in accordance with certain embodiments, the broker 104 can permit a user profile to be created even if only minimal personal information is provided to it by the user 102. In accordance with one embodiment, for instance, it may be possible for the user 102 to create a profile anonymously, whereby the broker 104 would only receive a user's active contact information, as opposed to their name, home address, phone number, etc. Of course, if the system is configured in such a manner that a registration fee is required by the user 102 to utilize the service, those of skill in the art will understand and appreciate that various levels of a user's personal and billing information can be provided to the broker 104 as necessary. In any event, it should be understood herein that the teachings of the disclosure can be modified as necessary to preserve the privacy of the user 102 as desired.

In accordance with one aspect of the disclosure, the user 102 is able to provide the broker 104 with permission to access their driving behavior and vehicle usage while they are subscribed to and request offer-based services to be provided. Vehicle usage includes but is not limited to the time of day the vehicle is usually operated, the time durations during which the vehicle is usually operated, the locations at which the vehicle is operated, vehicle acceleration and deceleration, vehicle speed, vehicle identification number, inertial forces and impulses the vehicle or its suspension experiences during the drive. Vehicle usage can also include automotive sensor data such as air temperature at air intake, air volume routed to the combustion chambers as measured by the mass airflow sensor, revolutions per minute of the engine (RPMs), the degree to which the throttle paddle is pressed, the point in time at which the driver was alerted that vehicle maintenance is necessary and the time difference between the maintenance alert and car maintenance actually being performed. Vehicle usage can furthermore include sensor data that is only accessible on the vehicle internal communication busses. Examples for this type of sensor data includes, but is not limited to wheel speed sensors, the degree to which the brake pedal has been pressed, and the point in time at which a particular vehicle safety system actively changed the driving dynamics of the vehicle. From this data on vehicle usage, numerous characteristics of a driver and driving habits may be inferred. For example, data about vehicle operation times and routes driven can be used to infer information about the morning or evening commute. Data from wheel speed sensors, throttle and brake paddle angle and angular rate when the paddles are pressed may be correlated with the state of agitation or calm of a driver. Data relating to the time between the driver being alerted of required maintenance for the vehicle and maintenance actually taking place may be correlated to how cost conscious the owner or the driver are of repairs.

Use of the vehicle usage data is not limited to the two examples above, of course, but it can be used in many other ways. For instance, the broker 104 may be allowed by the user to use the geographical location of the user 102 at various times by monitoring the location of a registered network-enabled mobile electronic device in their possession. This may be provided via various sources including, but not limited to, Wi-Fi networks and devices, global positioning system (GPS) networks devices, cellular networks and devices including tower or sector information, local area networks and devices, wide area networks and devices, Bluetooth networks and devices, and various other communication networks and devices. In addition to the user 102 registering with the broker 104, retailers and service providers 108 also register with the broker 104 and share details of any products or services they have available and/or are currently offering for purchase or use. The geographic location of the registered retailers and service providers 108 will also be given to the broker 104. While not required in all embodiments, it should be understood and appreciated herein that the retailers and service providers 108 may be required to pay a fee to the broker 104 in exchange for having their various services and products offered, marketed and advertised to end users.

According to certain embodiments, information related to the registered retailers and service providers 108 can be stored and maintained on the database repository 106 together with the registered users' shared information. In alternative embodiments, separate databases may be maintained by the broker 104 to store information provided collectively by the user 102 and the retailers 108. Those of skill in the art will understand and appreciate that the architecture of the disclosure may be structured and configured in many different manners without straying from the scope and spirit of the disclosure. Moreover, and as will be explained in detail below, the information database repository 106 may include geographic location data (e.g., GPS coordinate data, latitude-longitude data, or physical addresses) for both the registered users 102 and the registered retailers 108. Upon receiving geographical location data from the customer associated with a registered user 102, the broker 104 may then compare the geographical location data with that of its registered retailers 108 to determine which retailers 108 are located within a predetermined geographical proximity to the current location of the user 102.

With collective reference to both FIGS. 1 and 2, an exemplary illustration of a general mode of operation (indicated as reference numeral 200 in FIG. 2) for one embodiment of the disclosure is now provided. In accordance with this embodiment, retailers and service providers 108 register with a broker 104 and share details of any product or service offerings they have available for purchase or use (step 202 in FIG. 2). In addition to sharing offerings, the retailer 108 may also provide contact information, which indicates how a potential customer can contact them or travel to one of its store locations or that of another location where one or more of its products or services are being offered.

As explained above with reference to FIG. 1, various users 102 also register with the broker 106 and establish a user profile that indicates some of their interests, preferences and needs (step 204 in FIG. 2). For instance, a user 102 may send a request to the broker 104 authorizing it to use his or her current location. Examples of such methodologies for a user to transmit his or location include, but are not limited to, Wi-Fi beacons, GPS, cell tower IDs, network router IDs, Bluetooth IDs, and the like.

Information related to the driving behavior of a registered user 102 accessed by the broker 104 in accordance to one or more of the above-identified means is then stored in the broker's information repository database 106. In accordance with one aspect of the disclosure, the broker 104 is able to utilize the collected user's driving behavior information, as well as any personal profile and preference information provided by the registered user 102, to identify or match various products or services currently being offered by its registered retailers 108 that a relevant to the indicated interests of the user 102 (step 206 in FIG. 2). Depending on the level of permissions granted by the user 102 to the broker 104, in certain embodiments the broker 104 may be authorized to provide or send suggested product and service offerings to the user 102 on a pre-determined or periodic basis. In accordance with other exemplary embodiments, the user 102 may deny such access to the broker 104, whereby the broker can only provide such information to the user 102 upon receiving a specific request from the user. However, under no circumstance is the broker authorized to share any user 102 information with the retailers.

In accordance with one aspect of the disclosure, a user 102 can send a request to the broker 104 indicating that they are interested in receiving information related to current products or services being offered by one or more registered retailers 108 that meet certain criteria as defined by their interests, preferences and needs associated with their personalized user profile (step 208 in FIG. 2). Upon receiving the user's request, the broker 104 can identify and match current offerings with the user's profile (step 210 in FIG. 2).

To match submitted requests from registered users 102, in accordance with certain embodiments, the broker 104 utilizes a matching engine 110 that is associated with the system's information repository 106. It should be understood and appreciated herein that one or more of the disclosed components of the system 100, including the matching engine 110 associated with the system 100, may be embodied as a customization of an existing system, an add-on product, upgraded software, a stand-alone system (e.g., kiosk), a distributed system, a method, a data processing system, a device for data processing, and/or a computer program product. Accordingly, individual components of the system 100 may take the form of an entirely software embodiment, an entirely hardware embodiment, or an embodiment combining aspects of both software and hardware. Furthermore, the individual components of the system 100 may take the form of a computer program product on a computer-readable storage medium having a computer-readable program code means embodied in the storage medium. Any suitable computer-readable storage medium may be utilized, including hard disks, CD-ROM, optical storage devices, magnetic storage devices, and/or the like.

It should also be appreciated and understood herein that any database depicted or implied by FIG. 1, or any other database discussed herein (including the information repository or repositories indicated by reference numeral 106), may include any hardware and/or software suitably configured to facilitate storing identification, authentication credentials, and/or user permissions. One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of (e.g., matching) certain data may be accomplished through a proprietary algorithm or any desired data association technique known or routinely practiced by those of skill in the art. In addition, the association of data and profile information may be accomplished by any known manual means, or by any known automatic process. Illustrative automatic association techniques may include, for example, a database search, a database merge, GREP, AGREP, SQL, NoSQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

As is known by those of skill in the art, a key field partitions a database according to the high-level class of objects defined by the key field. For example, certain types of data may be designated as a key field in a plurality of related data tables and the data tables may then be linked on the basis of the type of data in the key field. The data corresponding to the key field in each of the linked data tables is often times the same or of the same type. Data tables having similar, though not identical, data in the key fields may alternatively be linked by using AGREP, for example. In accordance with one aspect of the disclosure, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will appreciate herein that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like. Moreover, the system 100 may be interconnected to an external data source via one or more networks (e.g., an external gateway) that include any hardware and/or software suitably configured to facilitate communications and/or process transactions between the system 100 and the external data source. Interconnection gateways are commercially available and known in the art and may be implemented through commercially available hardware and/or software, through custom hardware and/or software components, or through a combination thereof. In accordance with certain embodiments, an external gateway may be configured to deliver data directly to various components of the system 100, as well as interact with other systems and components/databases. In one embodiment, the external gateway may comprise web services that are used to exchange data between the various disclosed systems.

In some embodiments, information sent over a network associated with the system 100 may be encrypted to ensure the security of the data being transmitted. In addition, the network may be a shared, public, or private network, and may be implemented through any suitable combination of wired and/or wireless communication networks. Furthermore, the network may comprise a local area network (LAN), a wide area network (WAN), an intranet, and/or the Internet.

Returning specifically to FIGS. 1 and 2, a mode of operation associated with various embodiments of the disclosure allows the broker 104 to access, monitor and analyze the driving behavior of its registered users 102 by monitoring the geographical location of a network-enabled mobile electronic device that is in the physical possession of a registered user 102. When a user 102 requests that the broker 104 provide them with a listing of any potential offers available from its registered retailers 108, the broker 104 is able to determine the current location of the user 102 by tracking the geographical location of their network-enabled mobile electronic device at the time of the request. By knowing the approximate geographic location of the user 102, the broker 104 is able to transmit matching relevant offers that are within the current geographic vicinity of the user 102 (step 212 of FIG. 2). In other words, the service broker's matching engine 110 takes as input the user's geographic location and data from the information repository database 106 to generate a list of personalized and localized offers that match the indicated interests, needs and preferences defined by the user's profile.

In accordance with certain embodiments of the disclosure, the network-enabled mobile electronic device in the user's possession may be used to transfer its current location to the broker 104. For example, the device may transfer its current geographic location to a host server coupled to a network associated with the broker's information repository 106. In some embodiments, the current location of user's device may be provided automatically to the host server via a mobile communication network within which the mobile device is operating or roaming. In other embodiments, the current location of the mobile device may be entered using a menu selection on a user interface associated with the mobile device. The menu selection may include current location information previously stored on a storage device and received from the host server. Determining geographic location information may be performed automatically based on information received from equipment associated with the network, or through a GPS source (or other such communication transmitter source) that is associated with the mobile device. In other embodiments, the determination may be made manually. For example, the broker 104 and/or host server may request location information from the mobile device via the network. In some embodiments, the request may be a voice prompt, an audible prompt, and/or a visual prompt that is received by the mobile device. In accordance with these embodiments, the user 102, in response to the prompt, may use their mobile user interface to enter their current location. In other alternative embodiments, the broker 104 (when properly authorized and permitted to take such action) may automatically access and obtain the current geographical location information of the user 102 without prompting or notifying the user in advance.

In addition to the disclosure being configured to provide personalized, real-time and geographically relevant advertising information to the user 102, the system 100 is maintained in such a manner that no personal or private information of the user 102 is required to be shared with the retailers or service providers 108. In other words, the disclosure is architecturally structured such that only the centralized broker 104 is permitted and authorized to maintain and access the user's profile and registration information stored within the information repository database 106 for a period of time specified by the user. Such a system not only preserves the privacy and security of the user's personal information, but it also prevents the retailers and service providers 108 from sending the user unwanted and unauthorized solicitations and advertisements.

While this disclosure has been described as having an exemplary design, the disclosure may be further modified within the spirit and scope of this disclosure. This application is therefore intended to cover any variations, uses, or adaptations of the disclosure using its general principles.

We claim:

1. A real-time and privacy-preserving method for delivering personalized information to a user within a specific geographical location, the method comprising:
storing information specific to a user in a database maintained by a centralized brokerage service;
transmitting a user initiated request to the centralized brokerage service to provide a listing of products and services offered by retailers or third parties located in the approximate current geographical vicinity of the user;
utilizing the stored information of the user to generate a personalized listing of products and services offered within the approximate current geographical vicinity of the user; and
sending the generated personalized listing to the user.

2. The method of claim 1, wherein the stored information specific to the user is not accessible by or shared with the retailers or third parties, the third parties including vendors inside of an organization that offers the centralized brokerage services and vendors outside of an organization that offers the centralized brokerage services.

3. The method of claim 1, further comprising the step of registering the products and services offered by the retailers or third parties with the centralized brokerage service.

4. The method of claim 1, further comprising the step of permitting the centralized brokerage service to access geographical location information of the user after receiving suitable authorization from the user.

5. The method of claim 1, further comprising the step of determining the user's current geographical location.

6. The method of claim 5, wherein the step of determining the user's current geographical location comprises utilizing the location of a network-enabled mobile electronic device of the user.

7. The method of claim 1, further comprising the step of storing offers associated with the products and services offered by the retailers or third parties in the database maintained by the centralized brokerage service.

8. The method of claim 1, further comprising the step of permitting the centralized brokerage service to monitor and track at least a portion of the user's driving behavior, including monitoring and tracking various destinations traveled by the user that are relevant to the provision of real-time and personalized recommendations of location-based offerings to be provided to the user.

9. The method of claim 1, wherein the step of utilizing the stored information of the user to generate a personalized listing of products and services comprises utilizing a matching engine to identify products and services of which the user may have some personal interest in receiving from the centralized service, the matching engine being utilized without sharing the stored information specific to the user with any of the retailers or third parties offering the products and services.

10. A real-time and privacy-preserving method for delivering personalized information to a user within a specific geographical location, the method comprising:
registering offers with a centralized brokerage service, the offers being associated with various products and services offered by a plurality of retailers or third parties;
comparing the registered offers with user profiles stored in a database maintained by the centralized brokerage service to identify one or more registered offers of which a user may have some personal interest in receiving from the centralized brokerage service;
permitting the centralized brokerage service to access geographical location information of the user;
receiving a request from the user to view registered offers of any of the plurality of retailers or third parties that are located in the approximate vicinity of the user's current geographical location; and
sending to the user one or more registered offers that are being offered by a retailer or a third party in the approximate vicinity of the user's current geographical location.

11. The method of claim 10, further comprising the step of creating the user profiles by registering personal information of users with the centralized brokerage service, the personal information and any derivatives of the personal information, including any aggregation of personal information with that of other users, being accessible solely by the centralized brokerage service and not shared with the plurality of retailers or third parties.

12. The method of claim 10, further comprising the step of determining the user's current geographical location.

13. The method of claim 10, further comprising the step of storing the offers associated with the various products and services offered by the plurality of retailers or third parties in the database maintained by the centralized brokerage service.

14. The method of claim 10, wherein the step of permitting the centralized brokerage service to access geographical location information of the user comprises the user permitting the centralized brokerage service to monitor and track the user's driving behavior.

15. The method of claim 10, wherein the step of receiving a request from the user to view registered offers of any of the plurality of retailers or third parties that are located in the approximate vicinity of the user's current geographical location comprises determining if a network-enabled mobile electronic device of the user is in the approximate vicinity of the user's current geographical location.

16. The method of claim 10, wherein the step of comparing the registered offers with user profiles stored in a database comprises utilizing a matching engine to identify products and services of which the user may have some personal interest in receiving from the centralized service, the matching engine being utilized without sharing the stored information specific to the user or groups of users with any of the retailers or third parties offering the products and services.

17. A real-time and privacy-preserving method for delivering personalized information to a user within a specific geographical location, the method comprising:
providing a centralized brokerage service having a database containing a listing of various products and services offered by a plurality of retailers or third parties registered with the centralized brokerage service;
comparing the various products and services offered by the plurality of retailers or third parties with user profiles stored within the database, each user profile containing information representative of a registered user's personal preferences, interests and needs;
receiving a request from a registered user to view a listing of products and services offered by any of the plurality of retailers or third parties that match their user profile and are located in the approximate vicinity of the user's current geographical location;
determining the user's current geographical location; and
sending to the user the listing of products and services offered by the plurality of retailers or third parties that match their user profile;
wherein the user's profile contains personal information of the registered user, the personal information being accessible solely by the centralized brokerage service and not shared with the plurality of retailers or third parties.

18. The method of claim 17, further comprising the step of storing offers associated with the products and services offered by the plurality of retailers or third parties in the database.

19. The method of claim 17, further comprising the step of permitting the centralized brokerage service to access the geographical location information of the user by monitoring and tracking the user's driving behavior, if the user permits the centralized brokerage service to do so explicitly.

20. The method of claim 17, wherein the step of comparing the various products and services offered by the plurality of retailers or third parties with user profiles comprises utilizing a matching engine to identify products and services of which the user may have some personal interest in receiving from the centralized service, the matching engine being utilized without sharing the stored information specific to the user with any of the retailers or third parties offering the products and services.
